(19) United States
(12) Patent Application Publication
(10) Pub. No.: US 2026/0363455 A1
(43) Pub. Date: Nov. 19, 2026

(54) FITTED WATERPROOF WHEELCHAIR COVER

(71) Applicant: Gesy S. Duran, New York, NY (US)

(72) Inventor: Gesy S. Duran, New York, NY (US)

(21) Appl. No.: 19/211,625

(22) Filed: May 19, 2025

(51) Int. Cl. A47C 31/11; A61G 5/10

(52) U.S. Cl. CPC A47C 31/113; A61G 5/10

(57) ABSTRACT

According to some embodiments, a fitted wheelchair cover includes a waterproof surface (e.g., associated with a hydrophobic coating that repels water intrusion). The fitted wheelchair cover also has first and second openings and a shape of the wheelchair cover is adapted to receive a wheelchair via the openings and fit the wheelchair such that a person can sit on the wheelchair when it is covered. The cover receives a backrest of the wheelchair via the first opening secured by the first elastic portion near a side of the backrest opposite a seat bottom of the wheelchair. The cover also receives the seat bottom of the wheelchair via the second opening secured by the second elastic portion near a side of the seat bottom opposite the backrest of the wheelchair. In some embodiments, a pocket is formed in the wheelchair cover (e.g., to hold medicine and/or medical devices).

### BACKGROUND

In some cases, a person may want to avoid getting a wheelchair wet. FIG. 1 is an illustration of elements of a wheelchair 100. The wheelchair includes a backrest 110 and a seat bottom 120 forming a place for a person to sit. The wheelchair further includes wheels 130, push handles 140, handrails 150, seat sides 160, pedals 170, etc. Consider, for example, a person at a pool or a beach who sits on a wheelchair after swimming thus getting wheelchair wet. However, after the person dries off and changes clothes returning to the wet wheelchair may be an unpleasant experience. Moreover, some wheelchairs may have batteries or other components that might be damaged by exposure to water. Covering the wheelchair in towels is not practical because the towels may easily slide around and/or fall off.

Systems and methods for improvements in protecting wheelchairs from water are desirable.

### SUMMARY OF THE INVENTION

According to some embodiments, a fitted wheelchair cover includes a waterproof surface (e.g., associated with a hydrophobic coating that repels water intrusion). The fitted wheelchair cover also has first and second openings and a shape of the wheelchair cover is adapted to receive a wheelchair via the openings and fit the wheelchair such that a person can sit on the wheelchair when it is covered. The cover receives a backrest of the wheelchair via the first opening secured by the first elastic portion near a side of the backrest opposite a seat bottom of the wheelchair. The cover also receives the seat bottom of the wheelchair via the second opening secured by the second elastic portion near a side of the seat bottom opposite the backrest of the wheelchair. In some embodiments, a pocket is formed in the wheelchair cover (e.g., to hold medicine and/or medical devices).

Some embodiments provide a fitted wheelchair cover method, comprising: means for placing a fitted wheelchair cover over a wheelchair, wherein the fitted wheelchair cover includes a waterproof surface, a first opening with a first elastic portion, and a second opening with a second elastic portion, wherein a shape of the fitted wheelchair cover is adapted to receive a wheelchair via the first and second openings and fit the wheelchair such that a person can sit on the wheelchair when it is covered; means for receiving a backrest of the wheelchair via the first opening secured by the first elastic portion near a side of the backrest opposite a seat bottom of the wheelchair; means for receiving the seat bottom of the wheelchair via the second opening secured by the second elastic portion near a side of the seat bottom opposite the backrest of the wheelchair; means for exposing the fitted wheelchair cover to water; and means for removing the fitted wheelchair cover from the wheelchair.

With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is an illustration of elements of a wheelchair.

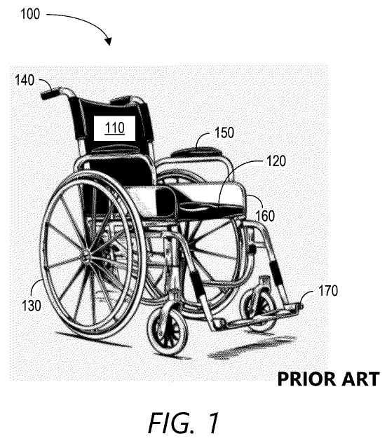

FIG. 2 is an example of a wheelchair and a wheelchair cover 210 in accordance with some embodiments.

FIG. 3A is a side view of a wheelchair cover and a wheelchair according to some embodiments.

FIG. 3B is a front view of a wheelchair cover and a wheelchair in accordance with some embodiments.

FIG. 3C is a side view of a wheelchair cover placed over a wheelchair according to some embodiments.

FIG. 3D is a front view of a wheelchair cover placed over a wheelchair in accordance with some embodiments.

FIG. 4 is a cross-sectional view of a wheelchair cover in accordance with some embodiments.

FIG. 5 is another wheelchair cover according to some embodiments.

FIGS. 6A and 6B show a wheelchair cover in use according to some embodiments.

FIG. 7A is a side view of a fitted wheelchair cover and a wheelchair according to some embodiments.

FIG. 7B is a front view of a fitted wheelchair cover and a wheelchair in accordance with some embodiments.

FIG. 7C is a side view of a fitted wheelchair cover placed over a wheelchair according to some embodiments.

FIG. 7D is a front view of a fitted wheelchair cover placed over a wheelchair in accordance with some embodiments.

FIG. 8 is a cross-sectional view of a fitted wheelchair cover in accordance with some embodiments.

FIG. 9 is another fitted wheelchair cover according to some embodiments.

FIGS. 10A through 10D show a fitted wheelchair cover in use according to some embodiments.

FIG. 11 is a method in accordance with some embodiments.

### DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

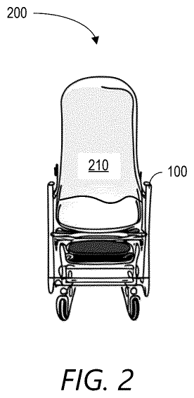

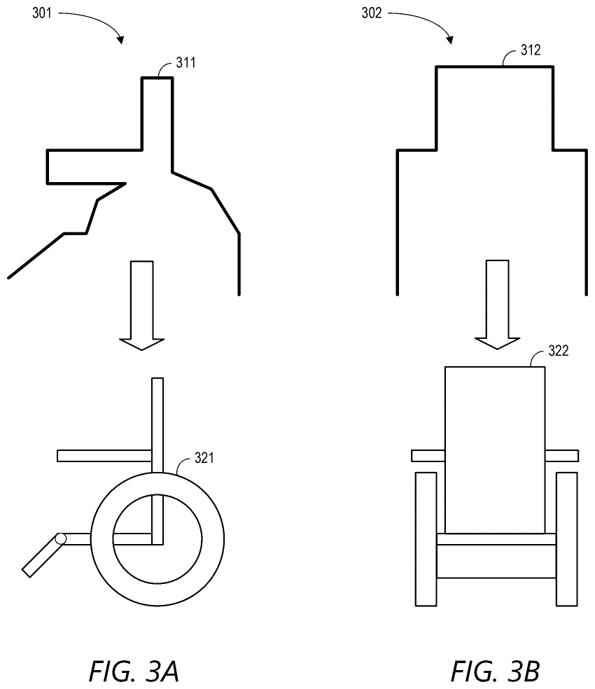

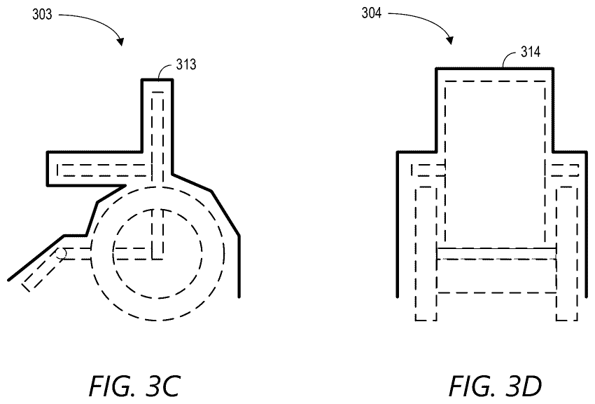

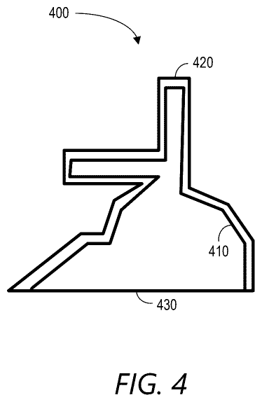

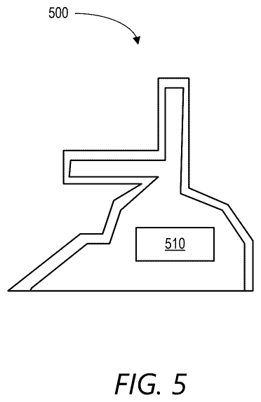

In some embodiments, a cover is provided to protect a wheelchair. For example, FIG. 2 is an example 200 of a wheelchair 100 and a wheelchair cover 210 in accordance with some embodiments. In particular, FIG. 3A is a side view 301 of wheelchair cover 311 and wheelchair 321 according to some embodiments. Similarly, FIG. 3B is a front view 302 of the wheelchair cover 312 and the wheelchair 322 in accordance with some embodiments. The cover 311, 312 may have a waterproof surface that resists or repels water, such as a surface associated with a hydrophobic coating that repels water intrusion. The cover 311 further has an opening (at the bottom of FIGS. 3A and 3B) and the shape of the wheelchair cover 311 is adapted to receive the wheelchair 321 via the opening and fit the wheelchair such that a person can sit on the wheelchair 321 when it is covered. FIG. 3C is a side view 303 of a wheelchair cover 313 placed over a wheelchair according to some embodiments. FIG. 3D is a front view 304 of the wheelchair cover 314 placed over a wheelchair in accordance with some embodiments.

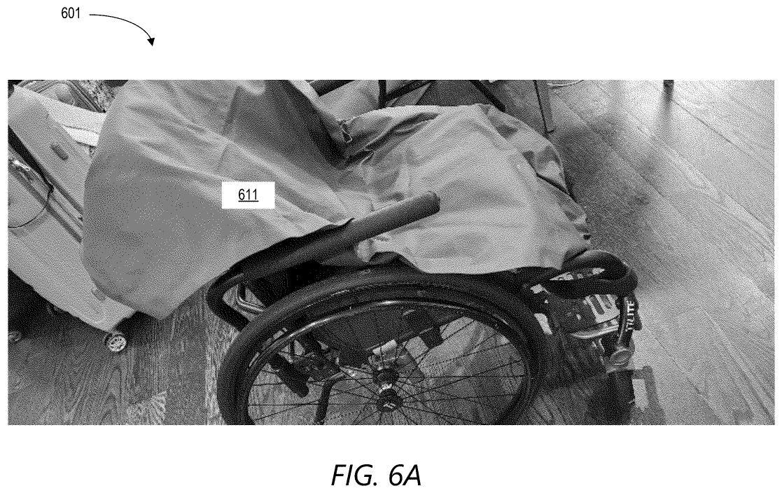

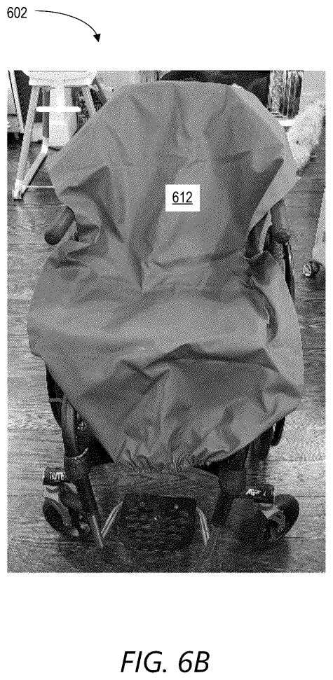

FIG. 4 is a cross-sectional view of a wheelchair cover 400 in accordance with some embodiments. The cover 400 has an inner surface 410 (that contacts a wheelchair) and a substantially waterproof (e.g., water resistant) outer surface 420. The cover 400 further has an opening 430 to receive a wheelchair. FIG. 5 is another wheelchair cover 500 according to some embodiments. In this case, the cover 500 has one or more pockets 510 that may be used to store medicine, medical devices, etc. away from water. The pocket 510 may be sealable via, for example, a zipper, buttons, snaps, a reusable, re-sealable sliding channel (e.g., similar to a ZIP-LOC® bag).

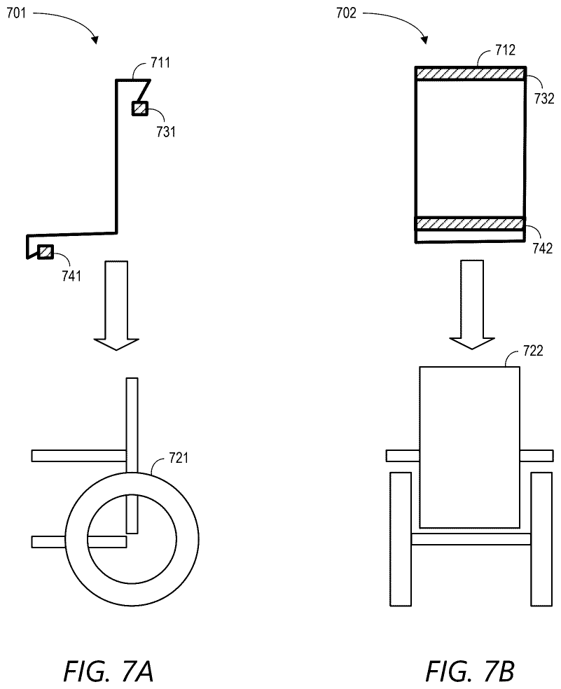

FIGS. 6A and 6B show examples 601, 602 wherein wheelchair covers 611, 612 are in use according to some embodiments. Thus, embodiments may provide ways to enjoy a dry wheelchair and protect wheelchair components from water.

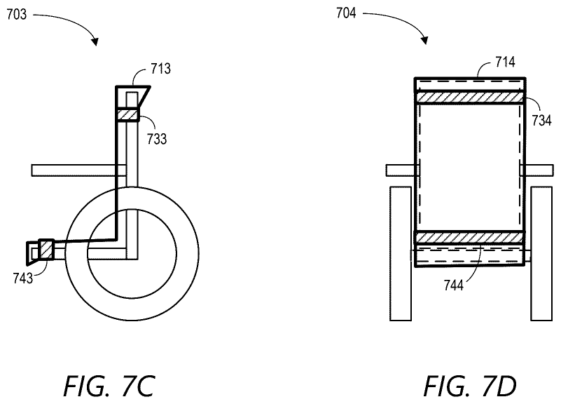

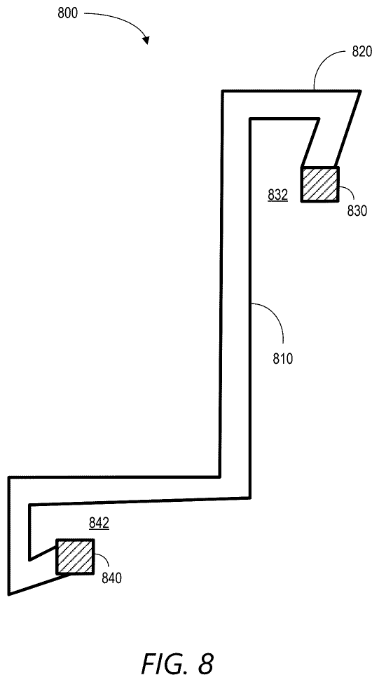

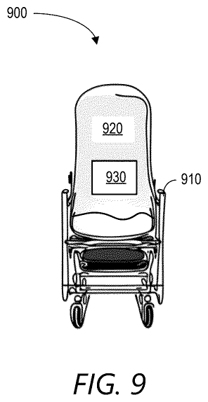

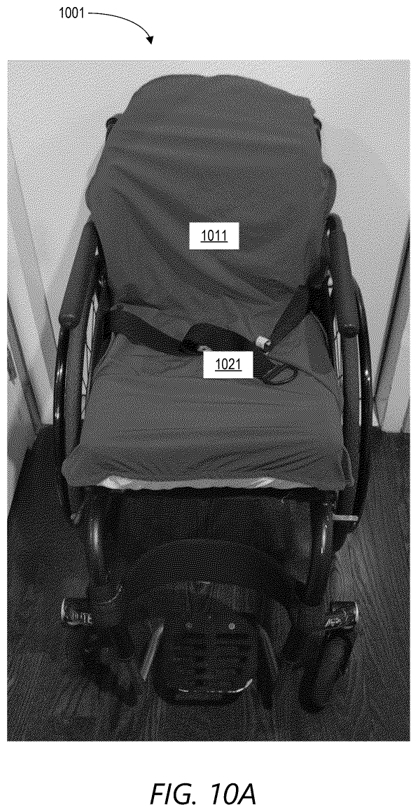

Some embodiments provide a “fitted” wheelchair cover to better secure the cover. For example, FIG. 7A is a side view 701 of fitted wheelchair cover 711 and wheelchair 721 according to some embodiments. In this case, the cover 711 includes a first opening with a first elastic portion 731. The cover 711 also includes a second opening with a second elastic portion 741.

The fitted wheelchair cover 711 is adapted to receive the wheelchair 721 via the first and second openings and fit the wheelchair 721 such that a person can sit on the wheelchair 721 when it is covered. In particular, a backrest of the wheelchair 721 is received via the first opening and secured by the first elastic portion 731 near a side of the backrest opposite a seat bottom of the wheelchair 721. The seat bottom of the wheelchair 721 is received via the second opening secured by the second elastic portion 741 near a side of the seat bottom opposite the backrest of the wheelchair 721.

Similarly, FIG. 7B is a front view 702 of the fitted wheelchair cover 712 and the wheelchair 722 in accordance with some embodiments. The cover 712 may have a waterproof surface that resists or repels water, such as a surface associated with a hydrophobic coating that repels water intrusion. The cover 712 further has first and second openings (near the top and bottom of FIGS. 7A and 7B) each associated with an elastic portion 732, 742.

FIG. 7C is a side view 703 of a fitted wheelchair cover 713, including elastic portions 733, 743, placed over a wheelchair according to some embodiments. FIG. 7D is a front view 704 of a fitted wheelchair cover 714, including elastic portions 734, 744, placed over a wheelchair in accordance with some embodiments.

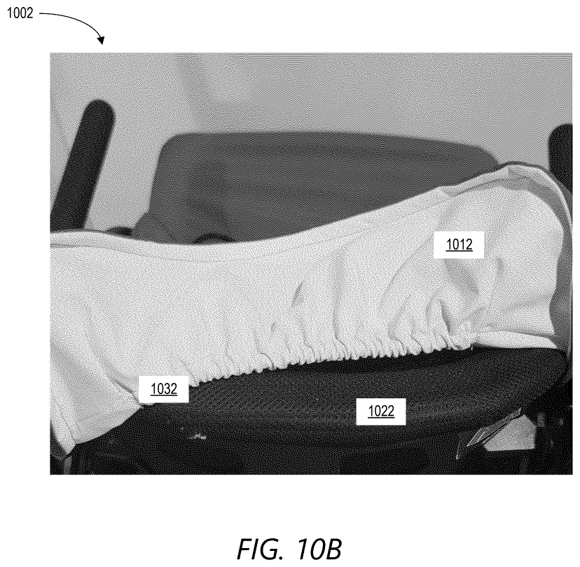

FIG. 8 is a cross-sectional view of a fitted wheelchair cover 800 in accordance with some embodiments. The cover 800 has an inner surface 810 (that contacts a wheelchair) and a substantially waterproof (e.g., water resistant) outer surface 820. The fitted wheelchair cover 800 is adapted to receive the wheelchair via a first opening 832 and a second opening 842 and fit the wheelchair such that a person can sit on the wheelchair when it is covered. In particular, a backrest of the wheelchair is received via the first opening 832 and secured by a first elastic portion 830 near a side of the backrest opposite a seat bottom of the wheelchair. The seat bottom of the wheelchair is received via the second opening 842 secured by a second elastic portion 840 near a side of the seat bottom opposite the backrest of the wheelchair.

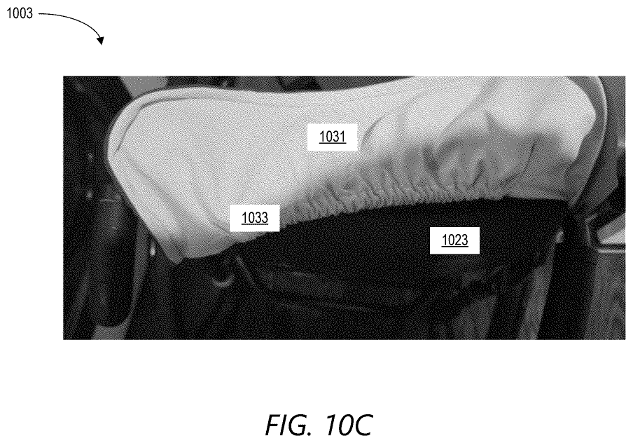

FIG. 9 is an example 900 of a fitted wheelchair cover 920 over a wheelchair according to some embodiments. In this case, the cover 920 has one or more pockets 930 that may be used to store medicine, medical devices, etc. away from water. The pocket 930 may be sealable via, for example, a zipper, buttons, snaps, a reusable, re-sealable sliding channel (e.g., similar to a ZIP-LOC® bag).

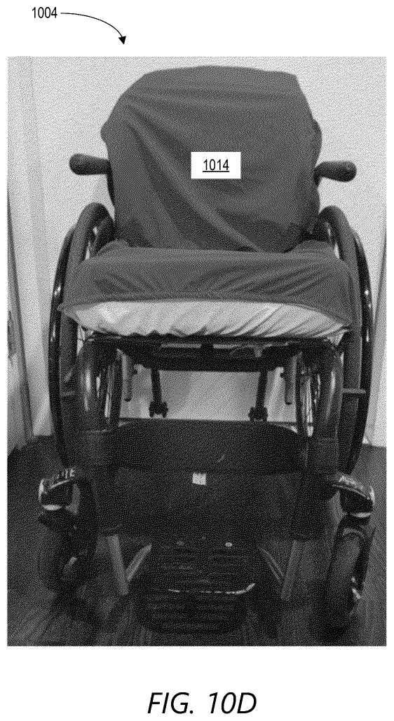

FIGS. 10A through 10D show examples 1001, 1002, 1003, 1004 wherein fitted wheelchair covers 1011, 1012, 1013, 1014 are in use according to some embodiments. As shown in FIG. 10A, the fitted wheelchair cover 1011 may be adapted to not cover a seatbelt 1021 of a wheelchair. FIG. 10B shows a fitted wheelchair cover 1011 partially receiving a wheelchair backrest 1022 via an expanded elastic portion 1032. FIG. 10C shows a fitted wheelchair cover 1013 after it completely receives a wheelchair backrest 1023. An expanded elastic portion 1033 has contracted and the fitted wheelchair cover 1013 is now securely attached to the wheelchair.

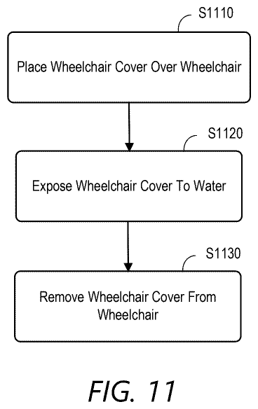

FIG. 11 is a method in accordance with some embodiments. At S1110, a wheelchair cover (e.g., a fitted wheelchair cover) is placed over a wheelchair. The wheelchair cover may include a waterproof surface, a first elastic portion, and a second elastic portion. The fitted wheelchair cover may, for example, receive a backrest of the wheelchair via the first opening, secured by the first elastic portion near a side of the backrest opposite a seat bottom of the wheelchair. The fitted wheelchair cover may also receive a seat bottom of the wheelchair via the second opening, secured by the second elastic portion near a side of the seat bottom opposite the backrest of the wheelchair. At S1120, a person may expose the fitted wheelchair cover to water. For example, the person may swim and sit on the fitted wheelchair cover without getting the wheelchair itself wet. At S1130, the person may remove the fitted wheelchair cover from the wheelchair. At this point, he or she may change into dry clothes and sit on the still dry wheelchair. Thus, embodiments may provide ways to enjoy a dry wheelchair and protect wheelchair components from water.

Although specific hardware has been described herein, note that any number of other elements may be provided in accordance with embodiments of the present invention. The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A fitted wheelchair cover, comprising:
a waterproof surface;
a first opening with a first elastic portion; and
a second opening with a second elastic portion,
wherein a shape of the wheelchair cover is adapted to receive a wheelchair via the first and second openings and fit the wheelchair such that a person can sit on the wheelchair when it is covered, by:
receiving a backrest of the wheelchair via the first opening secured by the first elastic portion near a side of the backrest opposite a seat bottom of the wheelchair, and
receiving the seat bottom of the wheelchair via the second opening secured by the second elastic portion near a side of the seat bottom opposite the backrest of the wheelchair.

2. The fitted wheelchair cover of claim 1, wherein the waterproof surface is associated with a hydrophobic coating that repels water intrusion.

3. The fitted wheelchair cover of claim 1, wherein the shape of the fitted wheelchair cover is adapted to not cover wheels of the wheelchair.

4. The fitted wheelchair cover of claim 1, wherein the shape of the fitted wheelchair cover is adapted to not cover push handles of the wheelchair.

5. The fitted wheelchair cover of claim 1, wherein the shape of the fitted wheelchair cover is adapted to not cover handrails of the wheelchair.

6. The fitted wheelchair cover of claim 1, wherein the shape of the fitted wheelchair cover is adapted to not cover seat sides of the wheelchair.

7. The fitted wheelchair cover of claim 1, wherein the shape of the fitted wheelchair cover is adapted to not cover pedals of the wheelchair.

8. The fitted wheelchair cover of claim 1, wherein the shape of the fitted wheelchair cover is adapted to not cover a seatbelt of the wheelchair.

9. The fitted wheelchair cover of claim 1, further comprising:
a pocket formed in the fitted wheelchair cover.

10. The fitted wheelchair cover of claim 8, wherein the pocket is sealable via at least one of: (i) a zipper, (ii) buttons, (iii) snaps, and (iv) a reusable, re-sealable sliding channel.

11. A method, comprising:
placing a fitted wheelchair cover over a wheelchair, wherein the fitted wheelchair cover includes a waterproof surface, a first opening with a first elastic portion, and a second opening with a second elastic portion, wherein a shape of the fitted wheelchair cover is adapted to receive a wheelchair via the first and second openings and fit the wheelchair such that a person can sit on the wheelchair when it is covered;
receiving a backrest of the wheelchair via the first opening secured by the first elastic portion near a side of the backrest opposite a seat bottom of the wheelchair;
receiving the seat bottom of the wheelchair via the second opening secured by the second elastic portion near a side of the seat bottom opposite the backrest of the wheelchair;
exposing the fitted wheelchair cover to water; and
removing the fitted wheelchair cover from the wheelchair.

12. The method of claim 11, wherein the waterproof surface is associated with a hydrophobic coating that repels water intrusion.

13. The method of claim 11, wherein the shape of the fitted wheelchair cover is adapted to not cover wheels of the wheelchair.

14. The method of claim 11, wherein the shape of the fitted wheelchair cover is adapted to not cover push handles of the wheelchair.

15. The method of claim 11, wherein the shape of the fitted wheelchair cover is adapted to not cover handrails of the wheelchair.

16. The method of claim 11, wherein the shape of the fitted wheelchair cover is adapted to not cover seat sides of the wheelchair.

17. The method of claim 11, wherein the shape of the fitted wheelchair cover is adapted to not cover pedals of the wheelchair.

18. The method of claim 11, wherein the shape of the fitted wheelchair cover is adapted to not cover a seatbelt of the wheelchair.

19. The method of claim 11, further comprising:
a pocket formed in the fitted wheelchair cover.

20. The method of claim 19, wherein the pocket is sealable via at least one of: (i) a zipper, (ii) buttons, (iii) snaps, and (iv) a reusable, re-sealable sliding channel.
